(19) United States
(12) Patent Application Publication
(10) Pub. No.: US 2006/0129464 A1
(43) Pub. Date: Jun. 15, 2006

(54) System and method for gathering and analyzing consumer preference data

(76) Inventor: Zhimin Chen, Aurora (CA)

Correspondence Address: Zhimin CHEN, 52 OSTICK STREET, AURORA, ON, L4G 7K5, CA

(21) Appl. No.: 11/284,947

(22) Filed: Nov. 23, 2005

(30) Foreign Application Priority Data
Nov. 24, 2004 (CA) 2,485,898

(51) Int. Cl. G06Q 30/00

(52) U.S. Cl. 705/26

(57) ABSTRACT

A method and an apparatus for gathering and analyzing consumer preference is disclosed. The method includes steps of providing offers; collecting consumer preference for the offers and analyzing the consumer preference by ranking the preference and applying pre-defined policy functions to obtain the most preferable specification with respect to the consumer preference; proposing new offers or updating offers according to the analysis result if appropriate and contacting relevant consumers; or collecting preference for the new offers, or updated offers.

### FIELD OF THE INVENTION

The present invention relates to a system and method for facilitating the offering and sale of a product or service, and is more particularly concerned with a computer-based system and method for gathering, analyzing and reacting to consumer preference data associated with said product or service in various industries.

### CROSS REFERENCE TO RELATED APPLICATION

Canadian patent application No. 2,485,898 filed on Nov. 24, 2004.

### BACKGROUND OF THE INVENTION

Understanding consumer preferences for products and services is vital to the long-term viability and profitability of a business. Reacting to changing consumer preferences and trends by targeting, tailoring and/or customizing products and services to specific consumers or niche consumer markets enables businesses to attract and retain loyal consumers.

Generally, consumers of products and services are viewed by businesses or vendors from two different perspectives: actual consumers and non-consumers. Vendors are aware of actual consumers and their preferences in view of past purchases made by these consumers from the vendor. Non-consumers comprise of individuals who have not made purchases from the vendor in the past, or for whom the vendor has no preference data. Non-consumers can, in turn, be further classified into two sub-groups of individuals. The first sub-group includes uninterested individuals having no need or desire to purchase products or services from the vendor. The second sub-group includes interested individuals having some degree of need or desire for the specific products or services, but such need or desire is not strong enough for the consumer to justify making the final decision to purchase the product or services.

Given the potential purchasing power of this second sub-group of consumers, it is important for the vendors to address the needs and desires of this sub-group of individuals and to encourage them to purchase their products or services. Consider the following typical example of an interested consumer shopping for shoes. The consumer visits a fashion retail store and finds an attractive pair of designer shoes costing $300.00. However, the consumer's acceptable price range is only $260.00. Although she is unwilling to purchase the shoes at $300.00, she would be willing to purchase the shoes if the price fell below $260.00. The interested consumer will not purchase the shows at the current price. Rather, she may choose to revisit the store in the future to determine whether the price for the designer shoes has been reduced. Alternatively, the interested consumer may choose to visit a competing retail store or refrain from purchasing the shoes entirely. From the perspective of the retail store, an immediate sale and potential long-term consumer have been lost. Since the retail store does not know why the interested consumer decided to forego the purchase of the designer shoes, they will be unable to target or tailor its marketing and sales campaigns to attract these interested consumers in the future.

Assuming that the designer shoe retail store typically has 300 consumers visit in any given day, and only 60 of these consumers actually purchase the aforementioned shoes, the stores consumer preference data is limited to the preferences of this small segment of purchasing consumers. The store has no data pertaining to the preferences of the remaining 240 potential consumers, including why these individuals chose not to purchase the shoes on that particular visit. It is reasonable to assume that at least 120 individuals within the sub-group of potential consumers are, in fact, interested purchasing the shoes in the near future if the price decrease, for example. Without proper systems and methods for tracking the preferences of interested and uninterested consumers, many vendors are overlooking a potentially large segment market of consumers. Knowing the preferences of these consumers would enable a vendor to better market its products and services to interested consumers so as to encourage additional actual sales.

Historically, there have been primarily three systems and methods used by vendors for gathering and analyzing consumer preference data. One common system and method used by vendors is to indirectly collect the consumer preference data based on the consumer's past buying behaviour. The data gathered by this method has typically focused on the products or services purchased and/or the method of payment used by the consumer in the past, including credit cards, debit cards, cheques and the like. The vendor would then use this data to target offers to specific consumers. These systems and methods cannot be effectively or accurately used to determine the current preferences of consumers, since the gathered data may be several years old and will often vary significantly from one purchase to another.

Another common system and method is to analyze a consumer's preferences by considering related data, such as navigation pattern. This is typically done by way of a click stream analysis. By analyzing the pattern of the click stream data, the system and method computes a “best guess” of the products and services that the consumer is interested in purchasing. While the “best guess” data may be useful to more accurately assess the consumer's future preferences, the process is largely speculative and may rely on data that does not actually represent the consumer's true preferences.

Alternatively, many vendors rely upon surveys to understand the preferences of their consumers. Surveys contain pre-defined questions which are aimed to elicit answers from consumers which enable the vendor to determine the preferences of target market groups. The vendor analyzes the answers to the survey questions to generate the preference data. The obvious limitation of surveys is that they identify trends among a group of consumers, but not the specific preferences and desires of the individual consumers.

Moreover, surveys also contain questions that are often directed to limited market groups, and, thus, lack the breadth that is necessary to determine the preferences of all interested consumers across numerous products and services. For example, a consumer survey system and method might contain ten categories of questions relating to ten different types of products, such as, furniture, electronics, fashion and the like. Each type of product may have multiple sub-products which must be covered by the survey, such as, for example, electronics may comprise televisions, DVD players, and digital cameras. Each sub-product may also have specific attributes and specifications that may influence consumer's preferences, such as the brand, model, size, color, and price and so on. Given the diversity of available products, sub-products and attributes, it is impractical for a survey system and method to gather survey data that is sufficiently detailed to provide an accurate summary of consumer preferences. Moreover, consumers are often reluctant to participate in surveys because of privacy concerns, lack of motivation or time. In order to encourage consumers to participate in surveys, most vendors must offer incentives or discounts. Such incentives or discounts may reduce the overall profitability of the vendor's business. Lastly, consumer surveys often fail to accurately target the consumer group of interest, resulting in irrelevant and useless consumer preference data.

Recently, with the increasing popularity of the Internet, several on-line mechanisms for gathering consumer preferences are also available to businesses. Content-based notification or subscription systems are now commonly used by businesses in a wide variety of industries, including travel scheduling, real estate, stock trading and news subscriptions. These on-line systems gather and store search queries inputted by subscribers to determine the preferences of the consumer/subscriber. Upon the occurrence of an event, such as, for example, a news flash, a new job or house posting, or the decline in the price of a stock, the system and method determines whether the event corresponds with any of the preferences previously inputted by the consumer/subscriber to the system. If the event corresponds to a consumer/subscriber, the event will be communicated to that consumer/subscriber, thereby enabling the consumer to react to the event, e.g. sell their stocks. Such subscription and notification systems and methods merely function as media and information “brokers”, and do not directly respond to the preferences of the consumers/subscribers. Rather, the system and method reacts to occurrence of events in the marketplace.

Accordingly, there is a need for a system and method for gathering, analyzing and reacting to the preferences of consumers, including actual consumers, interested consumers and uninterested consumers. There is a further need for a system and method for gathering reliable and accurate preference data that enables vendors to react to the current preferences of consumers. There is also a need for an in-store apparatus for gathering preference data relating to products and/or services directly from consumers so as to enable the vendor to react to the consumer's preferences.

### SUMMARY OF THE INVENTION

The present invention relates to a system and method for facilitating the gathering, analyzing and reacting to consumer preference data associated with one or more products or services. In preferred embodiments of the invention, the invention relates to a method for facilitating the offering and sale of a product by a vendor comprising the steps of generating a first offer for the product, presenting the first offer to one or more consumers, receiving preference data associated with the product from the one or more consumers, and generating a second offer for the product using the preference data. The second offer may also be presented to the one or more consumers and one or more third party consumers. The step of receiving the preference data may be directed to the sub-step of receiving the preference data from a first consumer and at least one additional consumer. The step of generating the second offer further may consist of the sub-step of analyzing said preference data associated with the first consumer with the preference data associated with the at least one additional consumer to generate at least one analysis result.

The method of the present invention may further comprise the step of generating at least one analysis by ranking the preference data associated with the first consumer and the at least one additional consumer. The step of ranking the preference data may comprise the sub-step of assigning a score to the preference data associated with the first consumer and the at least one additional consumer. The step of generating the second offer may comprise the sub-step of analyzing the preference data associated with the first consumer and the at least one additional consumer in accordance with one or more pre-defined policies. The step of presenting the second offer may further comprise the step of identifying the preference data of the one or more consumers that is satisfied by the second offer.

According to another aspect of the present invention, the present invention is directed to a system for facilitating the offering and sale of a product by a vendor comprising a preference database adapted to store preference data received from one or more consumers, wherein the preference data is associated with a first offer for the product, at least one interface connected to the preference database adapted to present the first offer to the one or consumer consumers and to receive the preference data, and at least one module connected to the preference database programmed to analyze said preference data. The at least one module may be adapted to generate a second offer for the product for output to the one or more consumers through the at least one interface. The second offer for the product may also be outputted to one or more third party consumers. Preference data may be receive from a first consumer and at least one additional consumer.

The system may comprise a preference analyzer module programmed to analyze the preference data received from the first consumer with the preference data received from the at least one additional consumer to generate the second offer. The preference analyzer module may assign a score to the preference data to rank the preference data received from the first consumer and at least one additional consumer. The system may also comprise a matching module connected to the preference database that is programmed to identify the preference data of the one or more consumer that is satisfied by the second offer.

### BRIEF DESCRIPTION OF THE DRAWINGS

For a better understanding of the present invention, and to show more clearly how it may be carried into effect, reference will now be made, by way of example, to the accompanying drawings which show preferred embodiments of the present invention, and in which:

FIG. 1 is a chart illustrating the types of consumers in the market for products and/or services;

FIG. 2 is a schematic diagram illustrating a system in an embodiment of the present invention;

FIG. 3 is a chart illustrating the types of preference data inputted and stored in the preference database in an embodiment of the present invention;

FIG. 4 is a chart illustrating the preference data inputted by one or more consumers in the example of the designer shoes in an embodiment of the present invention;

FIG. 5 is a flowchart illustrating steps in a method of facilitating the offering and sale of one or more products and/or services in an embodiment of the present invention;

FIG. 6 is a flowchart illustrating steps to be performed in analyzing the preference data in an embodiment of the present invention;

FIG. 7 is chart illustrating the results of the filtering of the preference data of FIG. 4 in the example of the designer shoes in an embodiment of the present invention;

FIG. 8 is a chart illustrating the results of the scoring and ranking of the preference data in the example of the designer shoes in an embodiment of the present invention;

FIG. 9 is a chart illustrating the results of the gross profit calculations in the example of the designer shoes in an embodiment of the present invention; and

FIG. 10 is a flowchart illustrating the steps to be performed in analyzing the preference data in a variant embodiment of the present invention.

### DETAILED DESCRIPTION OF THE INVENTION

The present invention relates to a system and method for use by a vendor for gathering consumer preference data supplied by consumers, analyzing the consumer preference data and reacting to the results of consumer preference data analysis by communicating with specific consumers whose preferences have been satisfied.

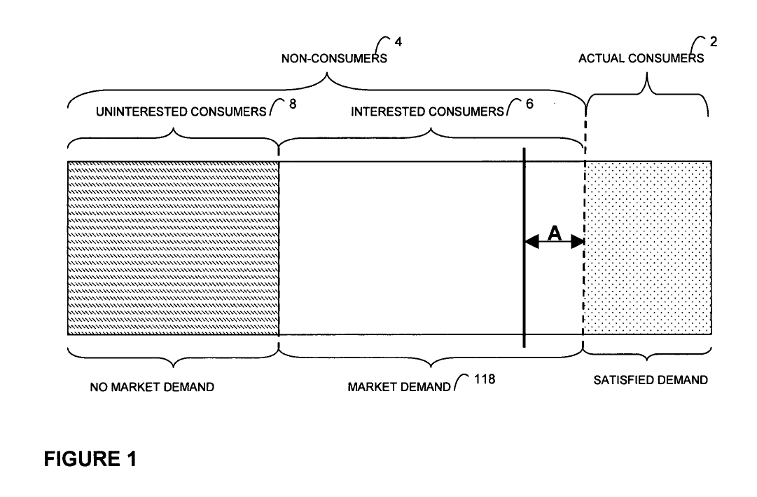

Referring to FIG. 1, the market for a product and/or service consists of actual consumers 2 and non-consumers 4. Typically, vendors are aware of the purchasing preferences of actual consumers 2 in view of the past purchases made by these consumers 2. The market of non-consumers 4 is comprised of interested consumers 6 and uninterested consumers 8. As discussed previously, interested consumers 6 are individuals or businesses having a need or desire for the subject good and/or service, but such need or desire is not strong enough to warrant purchasing the good and/or service. Alternatively, interested consumers 6 are individuals or businesses whose need or desire is not satisfied by the offer of the good and/or service presented by the vendor. In order to understand the market for a product and/or service, the vendor ideally should determine the number of interested consumers 6 that would be willing to purchase the good and/or service (e.g. the demand market A). In order to attract the interested consumers in the demand market A, the vendor may consider presenting the interested consumer with a new second offer. The new second offer may, for example, consist of a new price for the product and/or service, a redesigned version of the product or service, or additional features or factors which may encourage the interested consumers 6 to become actual consumers 2. The second offer may be a proposed offer generated by a third party adviser to the vendor, such as a marketing or consulting agency. The second offer may consist of consumer data related to specific consumer demographics or markets that the vendor should focus its marketing efforts, for example. By this design, the vendor may additionally determine whether the demand for a product and/or service is weak, thus possibly indicating that the market potential for the product and/or service has reached its full potential. It should be understood that the term “consumers” includes individuals (e.g. business-to-consumer transactions) and businesses (e.g. business-to-business transactions). Moreover, the market of non-consumers may also comprise one or more third party consumers who have not purchased products and/or services from the vendor in the past, and who are unaware of the vendors offers of products and/or services.

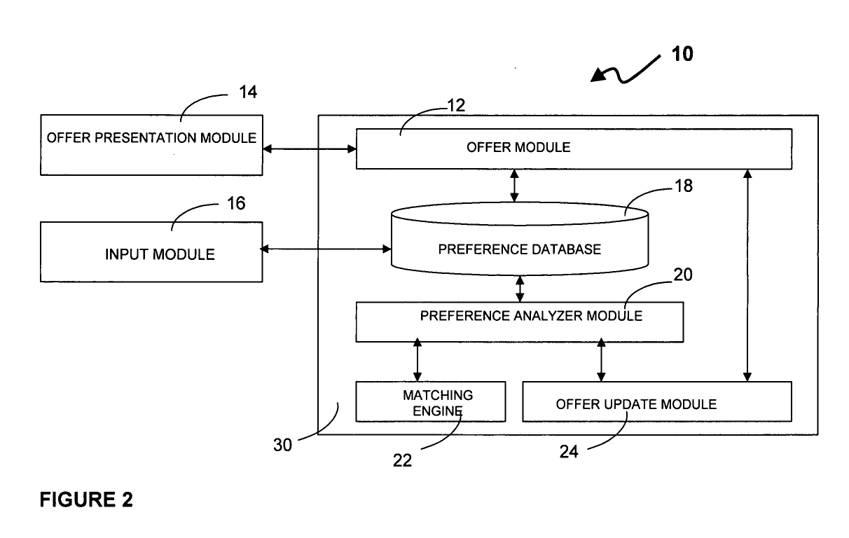

Referring to FIG. 2, an embodiment of a system for gathering, analyzing and reacting to consumer preference data submitted by a consumer is shown generally as preference system 10. Preference system 10 comprises one or more offer modules 12 which generate one or more first offers for product and/or service offers to be displayed to consumers using one or more offer presentation modules 14, one or more preference input modules 16 which receive the preference data from one or more consumers with respect to one or more products and services, a preference database 18 for storing the preference data, a preference analyzer module 20 programmed to analyze the consumer preference data in accordance with pre-defined policies and one or more generated analysis results, and a matching engine 22 programmed to generate matching results based on the second offer and the consumer preference data that is satisfied by the second offer. In this embodiment of the present invention, offer modules 12, preference database 18, preference analyzer module 20 and matching engine 22 reside on application server 30, although in variant embodiments of the present invention, one or more of these components may reside on different servers.

In the specification and in the claims, reference to the preferences of a consumer or the preference data may include, for example, the identity of products and/or services that the consumer is interested in purchasing, the specific attributes of the products and/or services, the prices at which the consumer would be willing to purchase the product sand/or services, consumer information, payment or accounting data, and any other data utilized by system 10. The specific attributes of the products and/or services may include its size, availability, colour, brand, model, financial terms, payment terms, features, add-ons, accessories, destination, duration and the quantity of products and/or services to be purchased. It should be understood that reference to the word “products” in the specification and in the claims may also include “services” or “products and services” together. Further, it should be understood that the term “attributes” may include any suitable features, characteristics or descriptive terms, for example, of the products and/or services.

Offer presentation module 14 may present the offers for products and services to the one or more consumer using a wide variety of means, including, but not limited to, in-store advertising, catalogs and flyers, television and radio commercials, Internet and email messages, and any other suitable method of offering products and services to consumers as is known in the art. It should be understood that offers may include conversations between in-store personnel and consumers, and word-of-mouth conservations between consumers.

The offer modules 12, offer presentation module 14 and/or preference input module 16 may reside on a system interface to enable offers to be displayed as output to consumers and receive consumer preference data as input. Data may be entered by consumers through the system interface to indicate their preferences for one or more products or services being offered by the vendor. It should be understood that the Vendor may also enter the preference data for the consumer. The consumer's preference data is collected and stored by the vendor in the preference database 18.

Preference database 18 may be used to store vendor data, consumer data, offer data, and preference data, for example. The consumer data may include the consumer's contact information, demographic data, and payment information, which may be used stored in the preference database 18. A vendor may retrieve the consumer data relating to any specific consumer or demographic of consumers to review their preference data. By this design, the vendor may utilize the gathered preference data to select the products to be included in advertising campaigns, such as flyers and catalogs.

The preference data may be stored the preference database 18 in accordance with predicate operators and range values as are commonly used with relational databases A predicate operator may be a Boolean operator such as equal to (“=”), less than or equal to (“≦”), or greater than or equal to (“≧”), for example. A predicate operator may indicate the relationship between a product and a corresponding attribute of the product. For example, if a consumer has inputted preference data into the system 10 indicating that they would be willing to purchase a vehicle if the price of that vehicle was “less than or equal to” $10,000.00, the preference data stored in the preference database 18 may include the identity of the vehicle that the consumer is interested in purchasing and the price at which the consumer would purchase the vehicle. Hence, the consumer would be willing to purchase the vehicle (i.e. “product”) if the price (i.e. “attribute”) is less than or equal to (i.e. “predicate operator”) $10,000.00.

The range values may consist of a unary value and a binary value, wherein the unary value represents the lower bound of the consumer's preference data (e.g. lowest preferred price) and the binary value represents the upper bound of the range (e.g. highest preferred price. It should be understood that the range values may also be a finite set of preference data, such as the integer range of 3 to 5 consisting of the finite integers 3, 4 and 5. Moreover, the consumer preference data may consist of an infinite set of values. The application can cover set operation with infinite set of elements. In our product, two multiple choices forms are also supported—a multiple choices with AND relationship among elements and a multiple choices with OR relationship among elements. We just use range as our preferred example.]

If a range of preference data is not required, the inputted preference data may be stored as a predicate operator (e.g. “equal to”) and a unary value. For example, the preference data may be stored in preference database 18 in accordance with the data fields shown in FIG. 2, where: “ID” is the identify of the interested consumer; “Product_ID” is the name or other identifier of the product or service; “Price_opr” is the predicate operator relating to the consumer's preferred price (such as equal to, greater than or less than); “Price_val1” is the unary value of the preferred price; “Price_val2” is the binary value of the preferred price, if any; “Adate_opr” is the predicate operator relating to the date on which the interested consumer would be willing or able to purchase the product or service; “Adate_val1” is the unary value of the preferred purchase date or period; and “Adate_val2” is the binary value of the preferred purchase date or period. It will be obvious to those skilled in the art that data to be stored in database 18 may be exist in a single database or other storage means, or distributed across multiple databases or storage means. Moreover, database 18 may be any suitable relational database that is commonly used in the art. It should be understood that preference data may be received from the one or more consumers using multiple choice forms or any suitable means for obtaining the preferences of consumers. The received consumer preference data may be stored by the system 10 of the preference invention using “AND” or “OR” relationships.

Preference analyzer 20 processes the consumer preference data based on the pre-defined policies to generate analysis results. The pre-defined policies may include questions or criteria in respect to the offered products or services which attempt to determine the maximum price at which the consumer would decide to purchase the product or service. The pre-defined policies may also be based on data from various market sources, such as the manufacturer's suggested retail price for a product or service, the prices adopted by competing vendors, and/or the wholesale price of the product or service. The preference analyzer 20 may also be designed to limit the range of consumer preference data to control the quality of data received from consumers. For example, preference analyzer 20 may be adapted to control or filter consumer preference data inputs which are intended by the consumer to skew the analysis results, such as, for example, the inputting of a purposively low preferred purchase price.

Analysis results outputted from preference analyzer 20 are provided to offer update module 24 in human and/or computer readable format. Offer update module 24 is used to determine whether existing offers for a product and/or service must be revised in view of the received preference data so as to encourage interested consumers to purchase the subject product and/or service. Offer update module 24 may also be programmed to perform real-time “what-if” scenario simulations and analyses based on the received consumer preference data.

If it is determined that the existing offers for products and/or services should be changed to attract interest consumers, matching engine 22 is adapted to generate matching results indicating the interested consumers to whom the revised offers for products and/or services should be sent. The output from the preference analyzer 20 and the matching engine 22 may be stored in database 18 for subsequent use by the system 10.

It should also be understood that in variant embodiments of the present invention, the offer module 12, offer presentation modules 14 and/or preference input modules 16 may be web-based. By this design, offer module 12, offer presentation modules 14 and/or preference input modules 16 would include a web engine 26 connected to the preference database 18, preference analyzer module 20 and a matching engine. Web engine generates the contents of the offers on web pages using data obtained through preference database, offer module and matching engine. Web engine and web pages may reside on a separate web server. Web pages are accessible over the Internet by a consumer, through the consumer's web browser. In variant embodiments of the invention, web pages may be accessible by consumers through other means, including closed or private networks, for example.

In further variant embodiments of the invention, the offers generated by the offer module 12 may be adapted to send and receive messages to and from the offer presentation module 14 and/or preference input modules 16 through a wireless network. Preference input modules 16 can include personal digital assistants (PDAs), cellular telephones, pagers, portable electronic mail messaging or other messaging devices, handheld organizers, portable computing devices or other devices. Messages containing offers may be transmitted by the vendor (i.e. sent to mobile devices and/or sent from mobile devices) as electronic mail messages, pages, or in other forms.

In another variant embodiment of the invention, the preference input module may not be web-based, but instead the consumer may call into a call center over the telephone or speak with the vendor's in-store personnel to provide their preferences, for example.

In a preferred embodiment of the invention, system 10 is used to facilitate the gathering and analyzing of consumer preference data and the generation of one or more offers for products and/or services to influence the buying decisions of interested consumers. The present invention allows vendors to target their marketing campaigns and advertising efforts to consumers that are interested in purchasing their products and/or services in the event of a special offer or sale. By this design, the vendor increase its likelihood of selling the product or service, and the interested consumer is able to purchase the product or service at a price that reflects his or her preferred price of the product or service.

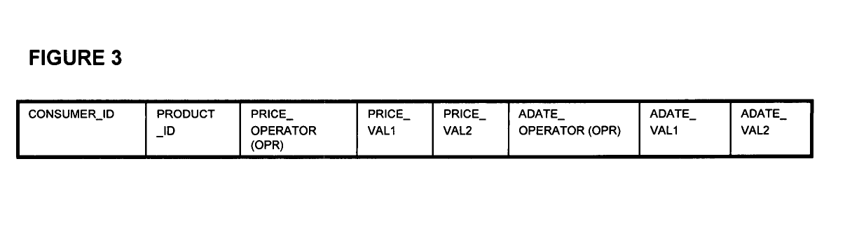

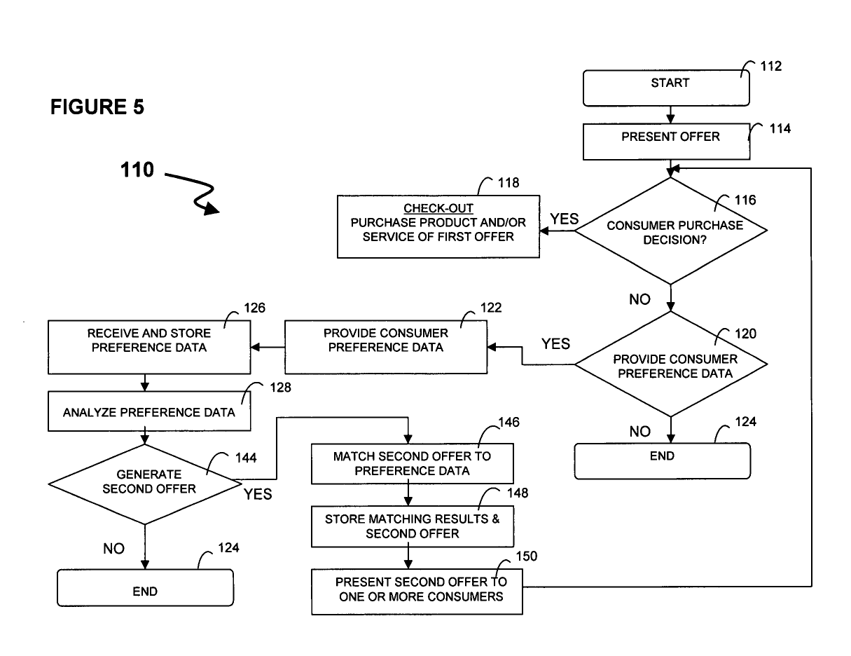

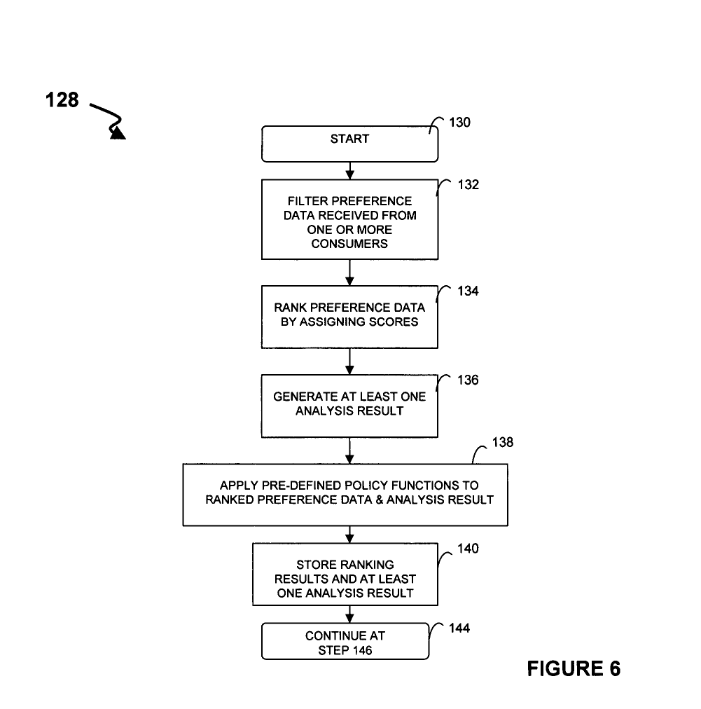

Referring to FIG. 5-9, steps in an embodiment of a method of gathering, analyzing and reacting to consumer preference data submitted by a consumer are shown generally as 110, and commences at step 112. The method of the present invention in FIGS. 2-8 will be described in the context of an offer by a vendor of a pair of designer shoes having a retail price of $300.00 to one or more consumers. It should be understood that the present invention may be utilized in respect to a wide variety of products and/or services.

At step 114, the vendor presents an offer to one or more consumers for a pair of designer shoes at a retail price of $300.00. A variety of methods of presenting the offer for the designer shoes may be utilized by the vendor, such as, for example, a flyer or catalog, a television or radio advertisement, an in-store or Internet-based display. Other means of providing consumers with the offers for the designer shoes may be implemented as are known in the art. It is understood that the offer of a pair of designer shoes may consist of only a description of the product or service, without the offered price.

Once presented with the offer for the designer shoes, the consumer must decide whether or not to purchase the subject product at step 116. If the consumer decides to purchase the designer shoes offered, they will proceed to the check-out at step 118 at which point their preference data in respect to purchase transaction will be inputted and stored in the vendor's preference database. If, at step 116, the consumer decides not to purchase the offered shoes, the consumer may then choose to provide their preference data in respect to the subject product to the vendor at step 120. If the consumer decides to provide their preference data to the vendor, they may do so at step 122 using the preference input modules 16 (not shown), for example. The preference data in respect to the designer shoes and any other product or service of interest to the consumer may then be stored in the preference database. The method ends at step 124 if the consumer chooses not to provide their preference data to the vendor.

At step 126, the preference data of the interested consumer has been received and stored by the preference database of the preference system 10. The inputted consumer preference data in respect to the designer shoes may consist of the price at which the consumer would decide to purchase the subject shoes, the availability of different colours or styles, or the date on which the consumer would have sufficient funds to purchase the shoes, for example.

The preference system (e.g. preference system 10 of FIG. 1) may require the interested consumer to log on to the system, by identifying him or herself using a logon name and password, for example. The consumer preference data may also consist of a unique identifier to identify the consumer, including, for example, his or her contact information, such as a telephone number or email address, which can be used by the vendor to communicate with the consumer. The contact information may also include the consumer's name and address. Other means of providing consumers with access to the pricing system may be implemented as known in the art.

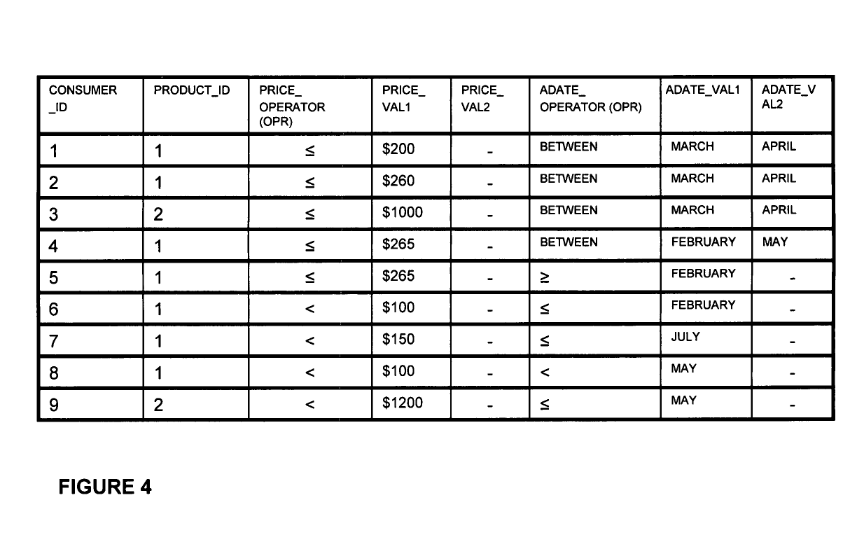

At step 128, the preference system analyzes the preference data inputted by the consumer at step 126 and stored in the preference database. For example, FIG. 4 illustrates the preference data inputted by nine interested consumers in respect to products and/or services offered by the vendor. The Product_ID values indicate that the inputted consumer preference data relates to two different products or services, namely Product_ID=1 and Product_ID=2. The Product_ID=1 preference data relate to the preferences of consumers interested in purchasing the pair of designer shoes. The Product_ID=2 relate to the preferences of consumers in respect to another pair of shoes. In total, the preference system has received and stored preference data from nine different interested consumers in respect to two different types or styles of shoes. Seven of the interested consumers have inputted data relating to the pair of design shoes (e.g. Product_ID=1). Two consumers have inputted data in respect to the other pair of shoes (e.g. Product_ID=2).

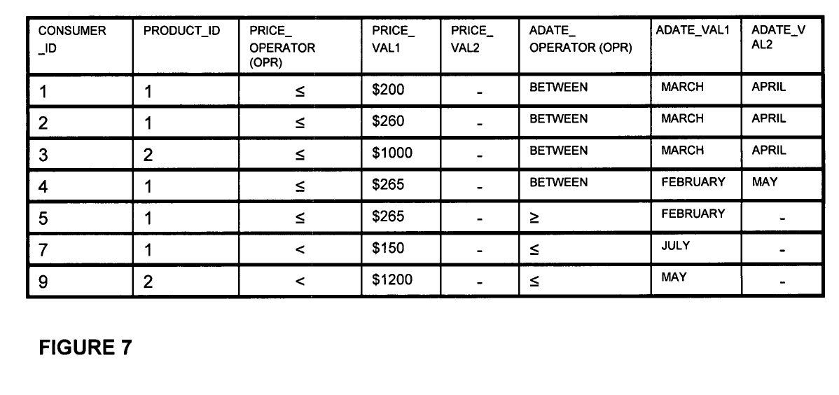

Reference is made to FIG. 5 which illustrates the steps performed by the preference analyzer module in analyzing the preference data received at step 128. The steps in FIG. 5 facilitate the determination of the range of preference data inputted by the interested consumers, and the price or date, for example, which yields the optimal number of sales of the products or services. The preference data contained in FIG. 4 will be utilized, by way of example only, to explain the steps in FIG. 5. The analysis of the preference data commences at step 130. At step 132, the system may control or filter the preference data to remove consumer preference data that is invalid, skewed or for any other purpose. In the example of the preferred embodiment of the present invention, the data may be filtered to remove the preference data relating to Product_ID=2. The data may also be filtered to remove the consumer preference data having a lower price range (e.g. Price_val1) of less than $140.00. The results of the filtering of the preference data at step 132 are shown in FIG. 7.

At step 134, the preference analyzer ranks the filtered consumer preference data from step 132. The ranking of consumer preference data is preferably used to determine the optimal values for one or more attributes for a product, such as the price at which the largest number of interested consumers would purchase a product. The ranking of the consumer preference data may involve determining the highest degree of intersection or overlap between the preference data of each of the consumers. It will be obvious to those skilled in the art that the filtered preference data may be ranked in accordance with any suitable criteria. In the example of the pair of designer shoes offered by the vendor, preference data was received from seven interested consumers (e.g. ID=1, 2, 4, 5 and 7). Each of the inputted preference data may be analyzed individually and/or in combination with the remaining inputted preference data. For example, the interested consumer identified as ID=1 inputted a preferred purchase price for the designer shoes of equal to or less than $200.00. The interested consumer ID=1 also inputted a preferred availability date or period of between March and April.

By comparing the preferences of the first interested consumer (e.g. ID=1) with those of the remaining six interested consumers, it is determined that preference data of the second, fourth and fifth interested consumers (e.g. ID=2, ID=4 and ID=5) are satisfied if the preferences of the first interest consumer are granted. Specifically, the second interested consumer ID=2 preferred a purchase price of equal to or less than $260.00 between March and April. The fourth interested consumer ID=4 had a preferred purchase price of equal to or less than $265.00 between February and May. Lastly, the fifth interested consumer ID=5 specified a preferred price of equal to or less than $265.00 any time during or after the month of February. Accordingly, if the preferences of the first consumer ID=1 are granted, the preferences of three other interested consumers will also be granted. A score may be attached to this ranking result totaling the number of interested consumers whose preference data are satisfied by the grant of each individual interested consumer's preference data. For example, if the preference data of the first consumer ID=1 is granted by the vendor, three resulting interested consumers will also have there preference data satisfied. Thus, the score assigned to the grant of ID=1 preference data would be 4 (e.g. 1+3=4, where the “1” relates to the first interested consumer and the “3” relates to the resulting interested consumers). At least one analysis result may be generated based on the ranking of the preference data at step 134.

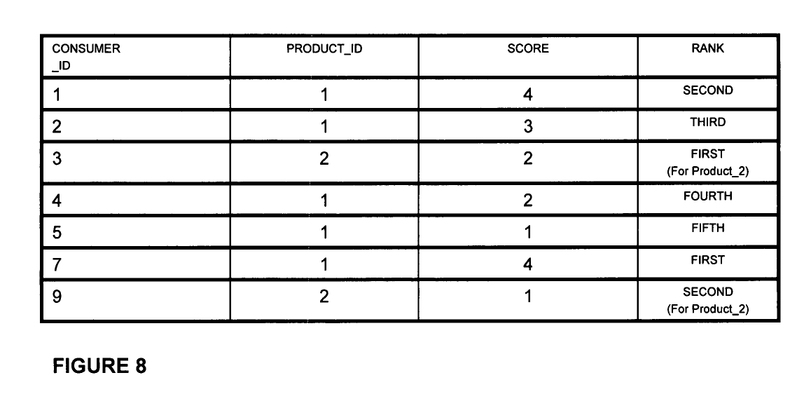

Reference is made to FIG. 8 which illustrates the results of the ranking and scoring of the preference data at Step 134 of FIG. 7 in respect to designer shoe example. The results have been ranked according to the score assigned to each of the consumer's preference data. The ranking and scoring results may be provided to the vendor in a human readable format as shown, or in a computer readable format suitable for further processing.

It should be understood that the preference data of each of the consumers may be ranked against preference data provided by the vendor (e.g. such as the range values of price between which the vendor would be will to sell the subject product). By this design, the ranking of the preference data may involve determining the highest degree of intersection or overlap between the preference data of vendor with the preference data of each of the consumers.

Returning to the steps of the preference analyzer module shown in FIG. 5, pre-defined policy functions or criteria may be applied at step 138 to the ranking and at least one analysis results generated at steps 134 and 136, respectively. In a preferred embodiment of the invention, the policy functions or criteria may be adapted to calculate the monetary profit resulting from the satisfaction of each of the interested consumer's preference data. Continuing the example involving the designer shoes, if the designer shoes cost $140.00 to manufacture, it is possible to calculate the gross profit for each of the consumers preference data. For the seventh interested consumer ID=7, the maximum possible price for the shoes which would still satisfy the seventh interested consumer's preferred price is $150.00. At a preferred price of $150.00, three resulting interested consumer's preferred prices are also satisfied. Accordingly, the possible gross profit for the vendor if the shoes were sold at a price of $150.00 would be would be $40.00. This is determined by multiplying the number of interested consumers whose preferred prices were satisfied (e.g. 4, ID=7 plus the 3 resulting interested consumer's) by the profit margin (e.g. $10, offer price minus the cost of manufacturing the shoes, namely $150.00−$140.00).

Similarly, for the first interested consumer ID=1, the maximum possible price at which they would be willing to purchase the shoes is $200.00. If the preferences of the first interested consumer ID=1 are satisfied, the preferences of a resulting three additional interested consumers are also satisfied. Hence, the gross profit margin for the shoes would be $240.00. This is obtained by multiplying the profit margin of $60.00 ($200.00−$140.00) by four (e.g. the number of interested consumers whose preference data has been satisfied by price the shoes at $200.00).

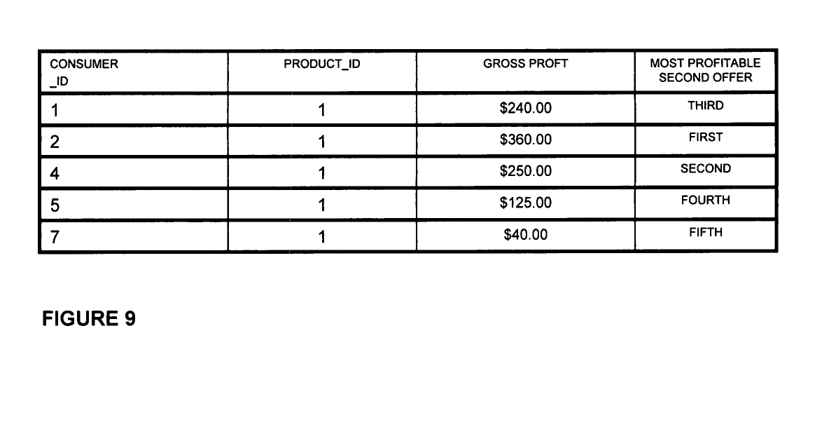

If the designer shoes were priced at $260.00 to satisfy the second interested consumer's ID=2 preference data, the gross profit margin would be $360.00. Again, this is calculated by multiplying the profit margin of $120.00 (e.g. $260.00−$140.00) by the number of interested consumers whose preference data has been satisfied by the offer, name three. FIG. 9 illustrates the result of the calculation of the gross profit margins in accordance with a preferred embodiment of the present invention, based on the example involving the sale of designer shoes by a vendor. In view of these gross profit margin results, the vendor will be able to determine the maximum price at which the interested consumers would be willing to purchase the designer shoes. The results of preference analyzer module may be stored by the preference system at step 140. The steps to be performed in analyzing the preference data are completed at step 142, and the method returns to step 144 of FIG. 5.

The preference data gathered by the preference system may be analyzed on a real-time basis, or at interval in the future. Preferably, the preference data is analyzed by the vendor with one or two months of the date on which the data was collected. By this design, the vendor will be better to react to the purchasing decisions and desires of consumers.

Returning to FIG. 5, the steps to be performed in gathering, analyzing and reacting to consumer preference data in respect to products and/or services in an embodiment of the present invention continues at step 144. At step 144, the system 10 determines whether the existing or new offers for products and/or services (e.g. the designer shoes) should be modified to reflect and react to the inputted consumer preference data. It should be understood that the determination of whether to modify or introduce new product or service offers may be completed by a computer decision-making process or personally by the vendor.

If new offers are introduced at 144, the system may be adapted to communicate the preference analysis results and one or more new offers for products and/or services to the matching engine to identify the relevant interested consumers at step 146 based on the previously gathered preference data. By this design, the match engine will determine the consumers whose preferences for the subject products and/or services are satisfied by the new offers, or the updated offers. The results of the matching process may be stored at step 148. It should be understood that the matching of the preference analysis results and/or the preference data to the interest consumers is optional, and this step may actually be completed by the preference analyzer module during the ranking and scoring of the preference data.

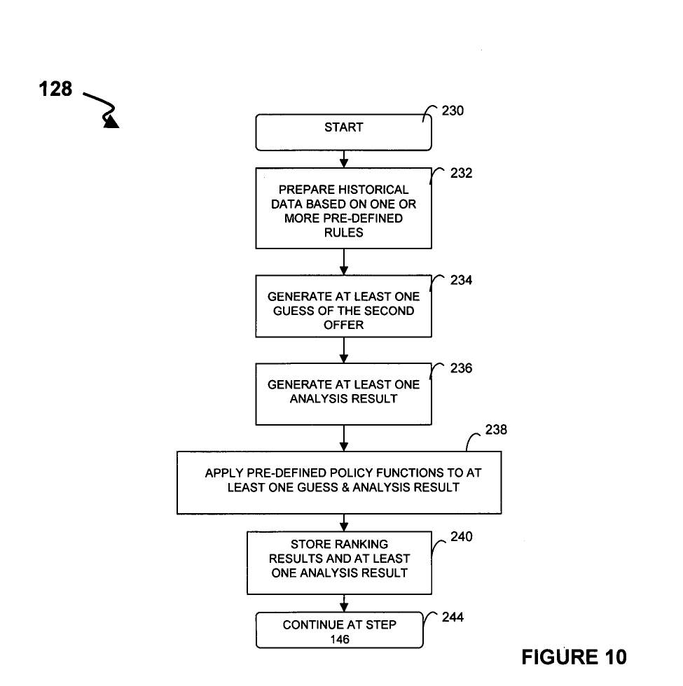

Referring to FIG. 10, a variant embodiment of the steps for analyzing the preference data at step 128 of FIG. 5 is shown. The steps of the variant embodiment of the preference analyzer module commence at step 230. In this variant embodiment, the preference analyzer module may be adapted to use historical data, such as, for example, the vendor's past sales figures and industry sales trends, to provide the best guess of the offer price that would yield the most preferable and/or profitable result. At step 232, the historical data is prepared based one or more pre-defined rules for generating matching results for the consumer preference data. Referring again to the example of a vendor offering designer shoes to consumer, the pre-defined rules may include the historical sales data of the offered shoes. Based on the vendor's historical data, the preference analyzer module determines at step 234 that the most profitable month for sales of the designer shoes or a comparable shoe is March (e.g. Adate=3). During that month, the price of the designer shoes was $264.00 (e.g. Price=$264.00), representing a 12% discount from the regular price of $300.00. Accordingly, a first guess of the second offer that will generate the most profit for the Vendor as result of selling designer shoes to attract current interest consumers is set at $264.00 during the month of March.

A second and third guess may be generated at step 234 to determine the accuracy of the first guess. For example, the second guess may be a price of $259.00 for the designer shoes during the month of March. The third guess may be a price of $269.00 for the designer shoes during the month of March. At step 236, the preference data received from the one or more interested consumers is ranked and scored against the historical data, namely the first guess, the second guess and/or the third guess. Pre-defined policy functions or criteria may be applied at step 238 to the ranking and scoring results generated at step 236. The ranking and scoring of the historical data against consumer preference data determines that the first guess of the optimal offer price for the designer shoes satisfies the preferred price of interested consumers ID=4 and ID=5. Accordingly, the gross profit margin for the first guess may be determined by multiplying the profit margin (e.g. $264.00−$140.00) by the number of interested consumers whose preference data has been satisfied by the first guess (e.g. two). Thus, the gross profit margin for the first guess would be $248.00. These steps are repeated for the second and third guesses. The gross profit margin for the second guess is $476.00 (e.g. $259.00−$140.00 times four, being the number of interested consumers whose preference data is satisfied by the second guess). The gross profit for the third guess is $0.00, since the third guess price of $269.00 fails to satisfy any of the interested consumer's preference data. Accordingly, the most profitable guess of the optimal offer price at which interested consumers would be willing to purchase the designer shoes during the month of March is $259.00.

With respect to the elements of the preference system for gathering, analyzing and reacting to consumer preference data as described in this specification, it will be apparent to those skilled in the art that the execution of various tasks associated with the methods of the present invention need not be performed by the particular component specified in the description of the preferred and variant embodiments of the invention, and that many configurations of the preference system are possible without departing from the scope of the present invention. For example, it will be obvious to those skilled in the art that the performance of tasks by a matching module may be performed by a different module, or through the use of multiple modules. As a further example, the steps performed by an offer module may instead be performed by the matching module or the preference analyzer module. It will also be obvious to those skilled in the art that the information and data stored in the system database may be distributed across multiple storage means.

It should be understood that the consumer may be required to provide additional information when they log on to the system and method of the present invention or submit their preference data via the one or more input modules. For instance, the consumer may be prompted to provide his or her financial payment information (such as a credit card or bank account number) in order to facilitate the immediate purchase of the product or service upon the satisfaction of their preference data by the second offer. By this design, the system and method of the present invention may automatically complete the consumer's purchasing transaction with the vendor when the second offer corresponds to the consumer's inputted preference data. Other means of automatically completing the transaction with the vendor may be implemented with the system and method of the present invention as are known in the art.

While what has been shown and described herein constitutes a preferred embodiment of the subject invention, it should be understood that various modifications and adaptions of such embodiment can be made without departing from the present invention, the scope of which is defined in the appended claims.

1. A method for facilitating the offering and sale of a product by a vendor, said method comprising the steps of:
(a) generating a first offer for said product;
(b) presenting said first offer to one or more consumers;
(c) receiving preference data associated with said product from said one or more consumers; and
(d) generating a second offer for said product using said preference data.

2. The method according to claim 1, further comprising the step of presenting said second offer to said one or more consumers.

3. The method according to claim 1, further comprising the step of presenting said second offer to one or more third party consumers.

4. The method according to claim 1, wherein step of receiving said preference data further comprises the sub-step of receiving said preference data from a first consumer and at least one additional consumer.

5. The method according to claim 1, wherein the step of generating said second offer further comprises the sub-step of analyzing said preference data associated with said first consumer with said preference data associated with said at least one additional consumer to generate at least one analysis result.

6. The method according to claim 5, wherein the step of generating said at least one analysis result further comprises the sub-step of ranking said preference data associated with said first consumer and said at least one additional consumer.

7. The method according to claim 4, wherein the step of ranking said preference data further comprises the sub-step of assigning a score to said preference data associated with said first consumer and said at least one additional consumer.

8. The method according to claim 1, wherein the step of generating said second offer further comprises the sub-step of analyzing and ranking said preference data associated with said first consumer against said preference data associated with said at least one additional consumer to generate at least one analysis result.

9. The method according to claim 1, wherein the step of generating said second offer further comprises the sub-step of analyzing said preference data associated with said first consumer and said at least one additional consumer in accordance with one or more pre-defined policies.

10. The method according to claim 1, wherein the step of generating said second offer further comprises the sub-step of analyzing said preference data of said one or more consumers in accordance with one or more pre-defined policies.

11. The method according to claim 1, wherein the step of generating said second offer further comprises the sub-steps of:
(i) analyzing said preference data of said one or more consumers and generating at least one analysis result; and
(ii) generating a second offer for said product using said at least one analysis result.

12. The method according to claim 1, wherein the step of presenting said second offer further comprises the step of identifying said preference data of said one or more consumers that is satisfied by said second offer.

13. The method according to claim 1, wherein the step of present said second offer further comprises the step of matching said second offer to said preference data of said one or more consumers that is satisfied by said second offer.

14. The method according to claim 1, wherein said first offer includes at least one attribute selected from the group consisting of: the product price, the product description, the availability date of the product, the quantity of the product available, payment options, and product accessories.

15. The method according to claim 1, wherein said second offer includes at least one attributed selected from the group consisting of: the product price, the product description, the availability date of the product, the quantity of the product available, payment options, and product accessories.

16. The method according to claims 5 and 8, wherein the step of generating said at least one analysis result further comprising the sub-step of assigning ranks to said preference data of one or more consumers in accordance with one or more pre-defined policies.

17. The method according to claim 1, wherein the step of generating a second offer further comprising the sub-step of:
(i) generating one or more matching results based on said second offer; and
(ii) identifying one or more consumers having preference data that is satisfied by said second offer.

16. A system for facilitating the offering and sale of a product by a vendor, said system comprising:
(a) a preference database adapted to store preference data received from one or more consumers, wherein said preference data is associated with a first offer for said product;
(b) at least one interface connected to said preference database adapted to present said first offer to said one or consumer consumers and to receive said preference data; and
(c) at least one module connected to said preference database programmed to analyze said preference data.

17. The system claimed in claim 16, wherein said at least one module generates a second offer for said product for output to said one or more consumers through said at least one interface.

18. The system claimed in claim 17, wherein said second offer for said product is outputted to one or more third party consumers.

19. The system claimed in claim 16, wherein said preference data is received from a first consumer and at least one additional consumer.

20. The system claimed in claim 16, further comprising a preference analyzer module programmed to analyze said preference data received from said first consumer with said preference data received from said at least one additional consumer to generate said second offer.

21. The system claimed in claim 20, wherein said preference analyzer module assigns a score to said preference data to rank said preference data received from said first consumer and at least one additional consumer.

22. The system claimed in claim 20, further comprising a preference analyzer module programmed to analyze and rank said preference data received form said one or more consumers in accordance with one or more pre-defined polices to generate second offer.

23. The system claimed in claim 20, further comprising a matching module connected to said preference database, wherein said matching module is programmed to identify said preference data of said one or more consumer that is satisfied by said second offer.
